(19) United States
(12) Patent Application Publication
(10) Pub. No.: US 2018/0369698 A1
(43) Pub. Date: Dec. 27, 2018

(54) METHOD OF CONDUCTING A COMPETITION WITH ELECTRONIC AND IN PERSON PORTIONS

(71) Applicant: Diva Werks, LLC, Jeffersontown, KY (US)

(72) Inventors: Paul A. Mattingly, II, Jeffersontown, KY (US); Nancy E. VanDyk, Brantford (CA); Blake McGrath, North Hollywood, CA (US)

(21) Appl. No.: 16/016,143

(22) Filed: Jun. 22, 2018

Related U.S. Application Data
(60) Provisional application No. 62/523,846, filed on Jun. 23, 2017.

(51) Int. Cl. A63F 13/798; A63F 13/35; A63F 13/79; A63F 13/837; A63F 13/814; A63F 13/828

(52) U.S. Cl. CPC A63F 13/798; A63F 13/35; A63F 13/828; A63F 13/837; A63F 13/814; A63F 13/79

(57) ABSTRACT

A method of conducting a competition with electronic and in person portions includes players participating in an electronic gaming environment. An automated system tracks the progress of players in an electronic game and issues invitation codes to top players meeting predetermined criteria. The top players may use the invitation codes to register for a final level event which is a live, in person competition utilizing skills represented in the electronic game.

### CROSS-REFERENCE TO RELATED APPLICATION

This application claims the benefit of priority to U.S. Provisional Patent Application Ser. No. 62/523,846, filed Jun. 23, 2017, entitled METHOD OF CONDUCTING A COMPETITION WITH ELECTRONIC AND IN PERSON PORTIONS, incorporated herein by reference.

### FIELD OF THE INVENTION

A method of conducting a competition with electronic and in person portions includes players participating in an electronic gaming environment. An automated system tracks the progress of players in an electronic game and issues invitation codes to top players meeting predetermined criteria. The top players may use the invitation codes to register for a final level event which is a live, in person competition utilizing skills represented in the electronic game.

### BACKGROUND OF THE INVENTION

Electronic games are played by millions of people on computers, smart phones and other devices. In many electronic games, players advance by proceeding through a series of levels where completion of the current level unlocks access to a subsequent level. Such games are typically won when a final level is completed. Other electronic games pit players against each other in head-to-head or team-vs-team competitions.

Some electronic games represent activities which occur in live, in person competitions or contests. For example, electronic basketball, tennis, football, soccer, and other sports-based games represent athletic competitions performed by actual people in live competitions. Similarly, a player's virtual performance in electronic dancing, cheerleading, diving, figure skating and other games may be evaluated using a scoring system corresponding to a system used to score live, in person performances.

### SUMMARY

The disclosed invention is a method for conducting a competition including both an electronic gaming portion and a live, in person competition portion. Players participate in, and advance through, an electronic gaming environment. Top players who meet predetermined criteria are invited to participate in a final level of the game. The final level is a live, in person event and activity requiring skills represented in the electronic gaming environment. Among the top players, the overall winner is determined by performance in the final level.

In one embodiment, the disclosed invention is a method of conducting a competition, comprising providing each of a plurality of players with a player account, wherein each player account includes an account identification code associated with the player and a progress record of the player in an electronic game; monitoring, by a processor, the progress record to determine if the progress record meets a predetermined criteria; assigning a unique invitation code to each player account wherein the progress record in that player account meets the predetermined criteria, the unique invitation code enabling players to register for a live final level event; conducting a live final level event for players, wherein players participate in the live final level event using skills represented in the electronic game; and determining a winner based on players' performance in the final level event. In further embodiments, the predetermined criteria is achieving a predetermined goal in the electronic game. In certain embodiments, the electronic game includes a plurality of levels, and wherein the progress record records the highest level completed by the player. In some embodiments, the electronic game is an electronic dance game, and wherein the live final level event is a live dance competition. In further embodiments, the electronic game is an electronic first-person shooter game, and wherein the live final level event is a live non-lethal shooting activity. In certain embodiments, the electronic game is an electronic sports game, and wherein the live final event is a live sports game. In some embodiments, the invention further comprises providing a server including the processor and a database, the server in electronic communication with the electronic game. In some embodiments, the player accounts are stored in the database. In further embodiments, the invention further comprises providing the electronic game. In certain embodiments, the invention further comprises providing a website including an access-restricted final level registration component, and wherein the unique invitation code is used to access the final level registration component.

In another embodiment, the disclosed invention is a method of conducting a competition including electronic and in person portions, comprising providing an electronic game and a server in communication with the electronic game over a communications network; providing each of a plurality of players with a player account having an account identification code associated with the player and a progress record indicating progress of the player in the electronic game; assigning a unique invitation code to each player account including a progress record that meets a predetermined criteria; enabling players to register for a final level event using the unique invitation codes; conducting a final level event for players, wherein players participate in the final level event using skills represented in the electronic gaming environment; and determining a winner based on players' performance in the final level event. In some embodiments, the final level event is a live competition between players. In further embodiments, each player accesses the electronic game via a computing device provided by the player. In certain embodiments, the player accounts are stored in a database stored on the server. In some embodiments, each player accesses their respective player account via a website linked to the database.

In a further embodiment, the disclosed invention is a method of conducting a competition, comprising providing each of a plurality of players with a player account, wherein each player account includes an account identification code associated with the player and a progress record for the player in an electronic game; comparing, by a processor, the progress record to a predetermined progress criteria; automatically generating a unique invitation code for each player account in which the progress record meets the predetermined criteria, the unique invitation code enabling players to register for a final level event; conducting a final level event for players, wherein players participate in the final level event using skills represented in the electronic game; and determining a winner based on players' performance in the final level event.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present invention will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 illustrates a high level block diagram of an exemplary electronic gaming environment according to an embodiment of the present invention.

FIG. 2 illustrates a high level flowchart of steps in conducting a generic competition with electronic and in person portions.

FIG. 3 illustrates a high level flowchart of steps in conducting a specific embodiment of a competition with electronic and in person portions.

### DETAILED DESCRIPTION OF THE PREFERRED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims. Any reference to “electronic game” within this document is a broad reference to games locally present on a computing device, online games accessed by a computing device, video games, computer games, mobile application “app” games accessed by mobile devices, such as smart phones, and other types of electronic games now known or later developed.

Specific quantities (spatial dimensions, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

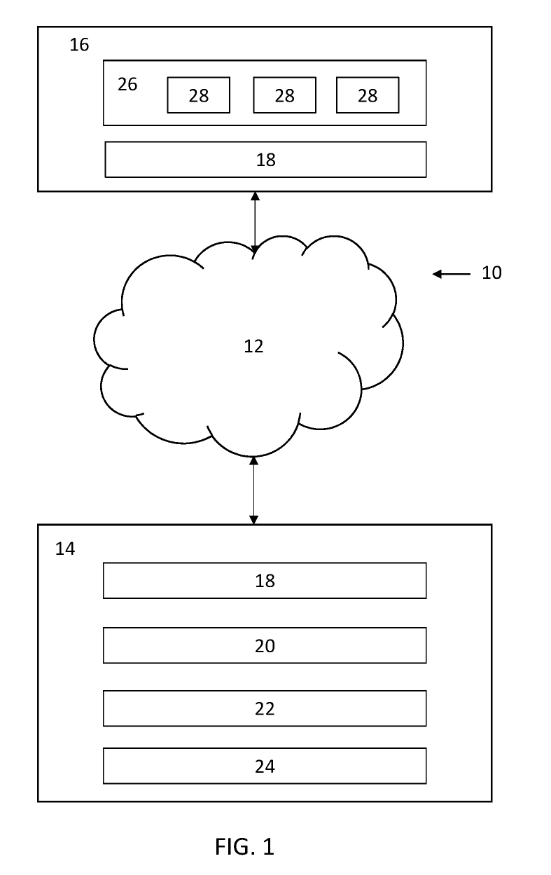

An exemplary embodiment of an electronic gaming environment 10 is illustrated in FIG. 1. The electronic gaming environment 10 includes a communications network 12, a computing device 14, and a server 16. It can be appreciated that, in some embodiments, additional servers 16 may be utilized with respect to the communications network 12, and in other embodiments, a single server 16 may be sufficient. The computing device 14 allows a player operating the computing device 14 to play an electronic game utilizing bidirectional communication between the computing device 14 and the server 16 over the communications network 12. In some embodiments, the communications network 12 is a data communications network, such as the Internet, a wireless communications link, an Ethernet connection, a telephone line, a digital subscriber link (DSL), a broadband cable link, or other data communications network known in the art. The game may be embodied in software stored on the server 16 and accessed by the communications device 14, such as a game playable in a web browser, or the game may be embodied in software hosted on the computing device 14.

The server 16 and computing device 14 each include a data processing system 18 including a processor, a memory, input/output circuits, and optionally, non-transient storage media. The processor communicates with the memory and the input/output circuits via one or more buses. The input/output circuits can be used to transfer information between the memory and other computer systems or a network using, for example, an Internet Protocol (IP) connection, wired connection or wireless connection. These components may be conventional components as are generally known in the art.

In some embodiments, the communications device 14 may be, for example, a smartphone, a general purpose desktop or laptop computer, a tablet computer, a personal data assistant, a game console, or other device capable of sending and receiving data via the communications network. The communications device 14 includes a user interface 20 as generally known in the art. A player may utilize the user interface 20 and communications device 14 to play an electronic game 22 embodied in software stored on the server 16 and accessed by the communications device 14, such as an electronic game playable in a web browser 24, or the electronic game 22 may be embodied in software hosted on the computing device 14, as shown in FIG. 1.

The server 16 includes a database 26 for storing a plurality of player accounts 28, one for each individual who plays the game. Each player account 28 includes an account identification code associated with the player and a progress record storing the progress of the player in the game.

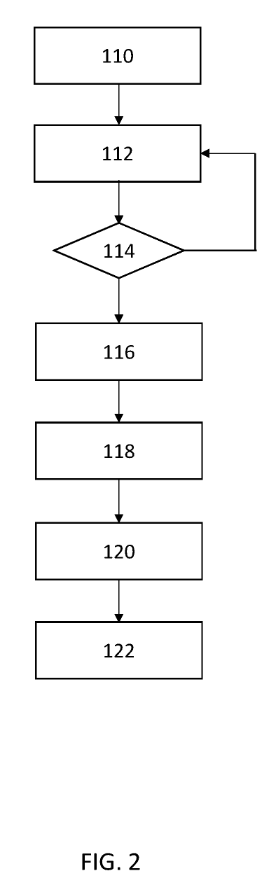

FIG. 2 describes a method of conducting a competition including electronic and in person portions, the method including:

110—a game provider providing a means for players to play an electronic game. The game provider may provide the electronic game 22 embodied in software, the computing device 14 for accessing the electronic game 22, the communication network 12, the server 16 (collectively, the electronic gaming environment 10), or a subset thereof. In certain embodiments, the game provider provides the electronic game 22 and the server 16, while the player provides his or her own computing device 14 (e.g., the player's personal computer, smart phone, or game console), and the communication network 12 is the Internet.

Each player is provided with a player account 28 having an account identification code and a progress record associated with the player. In some embodiments, the player is obligated to enter a username and password to access the player account 28, the electronic game 22 or both. In some embodiments, player accounts 28 are stored in the database 26 and controlled by the server 16, and may be accessible to the player via a website 30 linked to the database 26. As players play the electronic game 22, their progress in the electronic game 22 is recorded in their respective progress records. For example, in an electronic game 22 in which players advance sequentially through levels in the game, the progress record may record the player's highest completed level. In certain embodiments, the player account 28 is in electronic communication with the electronic game 22 and automatically updates to track the player's progress.

112—The server 16 automatically monitors player progress records by comparing the progress records to a predetermined criteria to determine if a given progress record meets the predetermined criteria. For example, in an electronic basketball game, the predetermined criteria may be for the player to play a game and beat the current champion team. For another example, in an electronic game based on building and improving dance studios, and conducting dance competitions therein, the predetermined criteria may be for the player to build ten dance studios with a total (in game) annual income of ten million dollars per year. For a further example, in an electronic adventure game based on space exploration, the predetermined criteria may be for the player to reach the center of the galaxy. For an additional example, in a first-person shooter game, the predetermined criteria may be for the player to kill all enemies in the game in the lowest possible time, wherein the ten players with the ten lowest times will be considered to have achieved the criteria. The predetermined criteria will typically be selected as a high achievement attainable only by a small fraction of the most skilled players in the game. In some embodiments, the predetermined criteria may be selected by the game provider to be attainable by less than 1%, less than 0.1%, or less than 0.01% of all players. In other embodiments, the predetermined criteria will be selected by the game provider to be attainable by the top 5, top 10, top 20, or top 50 players in the game, the top players being determined by meeting specific goals or besting other players in head-to-head or team-based competition.

In some embodiments, the server 16 automatically monitors player progress records by periodically comparing the progress records to a predetermined criteria to determine if a given progress record meets the predetermined criteria. For example, comparisons may be conducted annually, monthly, daily, hourly, or based on in-game “seasons.” In other embodiments, the server 16 automatically monitors player progress records continuously or substantially continuously.

114—If the server determines that a player progress record meets the predetermined criteria, the method proceeds to the next step with respect to that player (i.e., step 116), otherwise, the server continues to monitor the player progress record (i.e., step 112).

116—Upon identification of certain players as meeting the predetermined criteria in the electronic game, the server 16 assigns a unique invitation code to said players' player accounts 26. Encryption, passwords, and/or other means known in the art will preferably be used to prevent duplication of codes.

118—Each player having received a unique invitation code may then use the unique invitation codes to register for a final level competition. For example, a player may visit a website 30 controlled by the game provider, and enter the unique invitation code to access a restricted portion of the website. The player may then register online to attend and participate in a live event constituting the final level of the game. In some embodiments, once a unique code is used to register a player for the final event, that unique code is added to a list of blocked codes, and all attempts to register additional players for the final event using a code from the list of blocked codes are automatically denied. Optionally, the game provider may pay travel, lodging and other expenses of players attending and participating in the live event.

In some embodiments, only players who have met the predetermined criteria and received unique identification codes may participate in the final level live event. In other embodiments, selected other individuals may be invited to participate in the final level live event with the players, such as, for example, previous game winners, celebrities, or professionals in the fields represented by the game (e.g., a professional basketball player may be invited to participate in the final level live event for an electronic basketball game).

120—Players with unique invitation codes having registered for the final level event and, optionally, selected other individuals, then participate in the final level event. The final level is a live, in person event and activity requiring skills represented in the electronic game. For example, the final level in an electronic first-person shooter game may require top players to compete in a live, non-lethal, shooting activity, such as paintball, laser tag, archery, target shooting, skeet shooting, or similar activities. For another example, the final level in an electronic basketball game may require top players to compete in a live 1-on-1 basketball game or a basketball tournament wherein top players are assigned to teams in the tournament. For a further example, the final level of an electronic dance game may require top players to physically perform their dances for evaluation by qualified dance judges. In this manner, the top players' performance in the electronic game 22 serves as a prerequisite for the top players' opportunity to perform and compete in the live final level event. A panel of experts in the discipline the game is based on would judge players' performances, or in a sporting event, standard or modified rules of the sport would apply.

122—The winner or winners of the game are determined based on scoring of judges or by winning a head to head competition, depending on the nature of the activity being performed in the final event. In other words, in order to be determined as the winner of the electronic game, a player must demonstrate superior performance in both the electronic game and the live final event. It should be understood that an electronic game may have multiple winners over time, as newly minted winners replace older winners or as the game progresses through seasons.

The game provider will conduct the final level live event or will coordinate the conduction of the live event in combination with third-parties. The final level live event may optionally be broadcast on television, online, or via other means of content distribution to draw attention to the game and the top players. Optionally, players participating in the final level live event may receive prizes or rewards based on their performance in the final level live event.

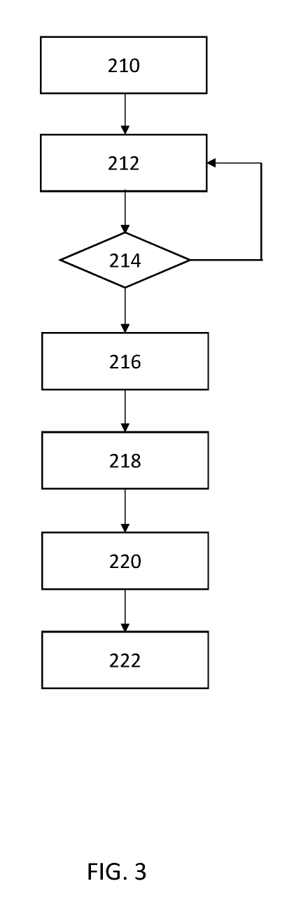

An exemplary embodiment of a method of conducting a competition with electronic and in person portions is discussed in reference to FIG. 3. While FIG. 2 is discussed above in reference to a generalized method, a similar flowchart is provided in FIG. 3 with respect to a method of conducting a dance contest with electronic and in person portions.

210—a game provider provides an electronic dance game 22 and a server 16 for monitoring players' progress in the electronic dance game 22. When playing the game, the player advances their virtual dancer through a series of virtual dance competitions; for example, city, county, state, regional, national, and international competitions. Scoring of the virtual dance competitions will be pre-programmed in the game, with choreography move sequences receiving pre-programmed scores based on a scoring system developed by certified dance competition judges. Each player is provided with a player account 28 having an account identification code and a progress record associated with the player. The player is obligated to enter a username and password to access the player account 28. The player accounts 28 are stored in the database 26 and controlled by the server 16. As players play the electronic dance game 22, their progress in the electronic game 22 is recorded in their respective progress records. In this embodiment, the progress record records the player's highest completed level of dance competition. The player account 28 is in electronic communication with the electronic dance game 22 and automatically updates to track the player's progress.

212—The server 16 automatically monitors player progress records by comparing the progress records to a predetermined criteria to determine if a given progress record meets the predetermined criteria. In this embodiment, the electronic dance game 22 includes twenty virtual dance competitions ranging from city competitions to international competitions, and the predetermined criteria is winning all twenty competitions.

214—If the server determines that a player progress record meets the predetermined criteria, the method proceeds to the next step with respect to that player (i.e., step 116), otherwise, the server continues to monitor the player progress record (i.e., step 112).

216—Upon identification of certain players as meeting the predetermined criteria in the electronic game, the server 16 assigns a unique invitation code to said players' player accounts 26.

218—Each player having received a unique invitation code may then use the unique invitation codes to register for a final level competition. The player may visit a website controlled by the game provider, and enter the unique invitation code to access a restricted portion of the website. The player may then register online to attend and participate in a live event constituting the final level of the game.

220—Players with unique invitation codes having registered for the final level event then participate in the final level event. The final level is a live, in person dance competition, judged by certified dance competition judges.

222—Players will be judged on their live dancing abilities using standard dance competition scoring and 1^{st} place, 2^{nd} place, 3^{rd} place, etc. finishers will be chosen as in typical live dance competitions. Therefore, in order to win the contest, a player must demonstrate superior performance in both the electronic game and the live final event.

The foregoing detailed description is given primarily for clearness of understanding and no unnecessary limitations are to be understood therefrom, for modifications can be made by those skilled in the art upon reading this disclosure and may be made without departing from the spirit of the invention.

What is claimed is:

1) A method of conducting a competition, comprising:
providing each of a plurality of players with a player account, wherein each player account includes an account identification code associated with the player and a progress record of the player in an electronic game;
monitoring, by a processor, the progress record to determine if the progress record meets a predetermined criteria;
assigning a unique invitation code to each player account wherein the progress record in that player account meets the predetermined criteria, the unique invitation code enabling players to register for a live final level event;
conducting a live final level event for players, wherein players participate in the live final level event using skills represented in the electronic game; and
determining a winner based on players' performance in the final level event.

2) The method of claim 1, wherein the predetermined criteria is achieving a predetermined goal in the electronic game.

3) The method of claim 1, wherein the electronic game includes a plurality of levels, and wherein the progress record records the highest level completed by the player.

4) The method of claim 1, wherein the electronic game is an electronic dance game, and wherein the live final level event is a live dance competition.

5) The method of claim 1, wherein the electronic game is an electronic first-person shooter game, and wherein the live final level event is a live non-lethal shooting activity.

6) The method of claim 1, wherein the electronic game is an electronic sports game, and wherein the live final event is a live sports game.

7) The method of claim 1, further comprising providing a server including the processor and a database, the server in electronic communication with the electronic game.

8) The method of claim 7, wherein the player accounts are stored in the database.

9) The method of claim 1, further comprising providing the electronic game.

10) The method of claim 1, further comprising providing a website including an access-restricted final level registration component, and wherein the unique invitation code is used to access the final level registration component.

11) A method of conducting a competition including electronic and in person portions, comprising:
providing an electronic game and a server in communication with the electronic game over a communications network;
providing each of a plurality of players with a player account having an account identification code associated with the player and a progress record indicating progress of the player in the electronic game;
assigning a unique invitation code to each player account including a progress record that meets a predetermined criteria;
enabling players to register for a final level event using the unique invitation codes;
conducting a final level event for players, wherein players participate in the final level event using skills represented in the electronic gaming environment; and
determining a winner based on players' performance in the final level event.

12) The method of claim 11, wherein the final level event is a live competition between players.

13) The method of claim 11, wherein each player accesses the electronic game via a computing device provided by the player.

14) The method of claim 11, wherein the player accounts are stored in a database stored on the server.

15) The method of claim 14, wherein each player accesses their respective player account via a website linked to the database.

16) A method of conducting a competition, comprising:
providing each of a plurality of players with a player account, wherein each player account includes an account identification code associated with the player and a progress record for the player in an electronic game;
comparing, by a processor, the progress record to a predetermined progress criteria;
automatically generating a unique invitation code for each player account in which the progress record meets the predetermined criteria, the unique invitation code enabling players to register for a final level event;
conducting a final level event for players, wherein players participate in the final level event using skills represented in the electronic game; and
determining a winner based on players' performance in the final level event.
